(19) United States
(12) Patent Application Publication
(10) Pub. No.: US 2026/0104257 A1
(43) Pub. Date: Apr. 16, 2026

(54) Estimation of a Pulled Implement’s Pose Based on Localized Topography Computed Using Vehicle Orientation

(71) Applicant: Ag Leader Technology, Inc., Ames, IA (US)

(72) Inventor: Josue Calderon, Apex, NC (US)

(73) Assignee: Ag Leader Technology, Inc., Ames, IA (US)

(21) Appl. No.: 19/354,587

(22) Filed: Oct. 9, 2025

Related U.S. Application Data
(60) Provisional application No. 63/705,750, filed on Oct. 10, 2024.

(51) Int. Cl. G01C 21/00; A01B 76/00; G01C 21/16

(52) U.S. Cl. CPC G01C 21/005; A01B 76/00; G01C 21/1654

(57) ABSTRACT

A method for estimating pose of a secondary apparatus connected to a primary vehicle includes obtaining position information for the primary vehicle and orientation information for the primary vehicle as the primary vehicle travels along a route. The method includes storing the orientation information with associated position information at geographic locations traversed by the primary vehicle. The method further includes obtaining position information for the secondary apparatus, and retrieving stored orientation information corresponding to a geographic location previously traversed by the primary vehicle that is near a current geographic location of the secondary apparatus. The method includes estimating pose of the secondary apparatus based on the retrieved stored orientation information and a spatial relationship between the primary vehicle and the secondary apparatus. A system is also provided.

### RELATED APPLICATIONS

This application claims priority to U.S. Provisional Patent Application No. 63/705,750, entitled “Estimation of a pulled implement's pose based on localized topography computed using vehicle orientation”, filed Oct. 10, 2024, hereby incorporated by reference in its entirety.

### FIELD OF THE DISCLOSURE

The present disclosure relates to position determination systems for towed implements and secondary vehicles, and more particularly, but not exclusively, to methods and systems for estimating the orientation of a towed implement using positioning data.

### BACKGROUND

Global Navigation Satellite System (GNSS) receivers are commonly used to determine vehicle position. These receivers are typically mounted at elevated locations on a vehicle, such as on the roof, to maintain clear line of sight with satellites. The GNSS receiver reports its own position, which often differs from the position of interest, such as a ground contact point or implement application point.

When a vehicle operates on non-planar terrain, it experiences pitch and roll. To accurately determine the position of a point offset from the GNSS receiver, such as a ground contact point, the receiver's position measurement must be corrected for the vehicle's orientation. This correction typically requires measuring the vehicle's pitch and roll using inertial measurement units (IMUs), magnetometers, multi-antenna GNSS systems, or similar orientation sensing equipment.

In applications involving towed implements, such as agricultural equipment, it is desirable to know the precise position of the implement, particularly the location where the implement contacts the ground or applies material. A GNSS receiver can be mounted on the implement to determine its position. However, similar to the vehicle, the implement's orientation must be known to accurately determine points of interest offset from the GNSS receiver location.

The implement's orientation cannot simply be assumed to match the towing vehicle's current orientation. The vehicle and implement may be at different positions on varying terrain, resulting in different pitch and roll values. Additionally, the implement may not follow the exact path of the vehicle due to factors such as side-slip on sloped terrain or tracking differences on curved paths.

Equipping the implement with a complete orientation sensing system adds significant cost and complexity. There remains a need for methods and systems to accurately determine implement orientation and position using simplified equipment on the implement itself.

### SUMMARY

Therefore, it is a primary object, feature, or advantage to improve over the state of the art.

It is a further object, feature, or advantage to provide a method for estimating the orientation of a towed implement without requiring orientation sensing equipment on the implement.

Another object, feature, or advantage is to determine implement pitch and roll using historical pose data from a towing vehicle.

Yet another object, feature, or advantage is to provide accurate position determination for towed implements using only positioning receivers.

A further object, feature, or advantage is to reduce the cost and complexity of implement positioning systems.

Another object, feature, or advantage is to compensate for terrain-induced orientation differences between a vehicle and a towed implement.

A still further object, feature, or advantage is to account for heading differences between a vehicle and implement when estimating implement orientation.

Yet another object, feature, or advantage is to utilize a position buffer indexed by geographic coordinates to store vehicle pose data.

Another object, feature, or advantage is to enable accurate implement positioning on both straight and curved guidance paths.

A further object, feature, or advantage is to provide a method that accommodates implement path deviations from the vehicle path.

Yet another object, feature, or advantage is to calculate terrain plane orientation from historical vehicle pitch and roll measurements.

Another object, feature, or advantage is to project implement heading vectors onto terrain planes to determine implement orientation.

A still further object, feature, or advantage is to enable precision agriculture applications by accurately determining implement application points.

Yet another object, feature, or advantage is to provide a system that operates effectively on variable terrain including hills and slopes.

A further object, feature, or advantage is to allow generation of topographic maps from accumulated vehicle pose data.

Another object, feature, or advantage is to provide real-time implement orientation estimation during operation.

Yet another object, feature, or advantage is to utilize spatial delay compensation based on the distance between vehicle and implement.

A still further object, feature, or advantage is to provide a method adaptable to various types of towed implements and agricultural equipment.

Another object, feature, or advantage is to enable accurate ground contact point determination for towed implements.

A further object, feature, or advantage is to improve positioning accuracy without requiring complex sensor fusion algorithms on the implement.

One or more of these and/or other objects, features, and advantages of the present disclosure ill become more apparent from the following detailed description, claims, and accompanying drawings. No single embodiment need to meet or provide each and every object, feature, or advantage. Different embodiments may have different objects, features, or advantages.

According to one aspect, a method for estimating pose of a secondary apparatus connected to a primary vehicle includes obtaining position information for the primary vehicle and orientation information for the primary vehicle as the primary vehicle travels along a route. The method includes storing the orientation information with associated position information at geographic locations traversed by the primary vehicle. The method further includes obtaining position information for the secondary apparatus, and retrieving stored orientation information corresponding to a geographic location previously traversed by the primary vehicle that is near a current geographic location of the secondary apparatus. The method includes estimating pose of the secondary apparatus based on the retrieved stored orientation information and a spatial relationship between the primary vehicle and the secondary apparatus. The secondary apparatus may include a towed implement. Obtaining position information may include receiving data from positioning receivers mounted on the primary vehicle and the secondary apparatus. The positioning receivers may include Global Navigation Satellite System (GNSS) receivers. The orientation information may include pitch and roll measurements of the primary vehicle. Storing the orientation information with associated position information may include storing vehicle pose measurements in a position buffer indexed by geographic coordinates. The position buffer may store vehicle pose measurements at predetermined distance intervals along the route. Retrieving stored orientation information may include identifying a historical vehicle pose measurement corresponding to a geographic location proximate to the current geographic location of the secondary apparatus. Identifying the historical vehicle pose measurement may include calculating distances between the current geographic location of the secondary apparatus and each geographic location in stored orientation information, and selecting orientation information with a minimum calculated distance. The method may further include identifying a plurality of closest historical vehicle pose measurements to the current geographic location of the secondary apparatus, applying a smoothing filter to orientation values from the plurality of closest historical vehicle pose measurements, and using the smoothed orientation values for estimating pose of the secondary apparatus. The spatial relationship may include a heading difference between the primary vehicle and the secondary apparatus. Estimating pose of the secondary apparatus may include accounting for a directional offset between the primary vehicle and the secondary apparatus when determining how terrain orientation affects the secondary apparatus. Estimating pose may include calculating a terrain plane orientation at the current geographic location of the secondary apparatus based on the retrieved stored orientation information, projecting a heading vector of the secondary apparatus onto the terrain plane, and computing pitch and roll orientation of the secondary apparatus from components of the projected heading vector. Calculating the terrain plane orientation may include applying a rotation matrix defined by extracted pitch and roll values to a vertical reference vector to obtain a terrain normal vector. Projecting the heading vector may include calculating a heading difference vector representing angular offset between primary vehicle heading and secondary apparatus heading, and decomposing the heading difference vector into a component perpendicular to the terrain plane and a component parallel to the terrain plane. Computing pitch orientation of the secondary apparatus may include calculating an arctangent of a ratio of the perpendicular component to the parallel component. Computing roll orientation of the secondary apparatus may include calculating a cross product between the heading difference vector and a perpendicular terrain vector, and computing an arctangent based on components of the cross product. The method may further include determining a contact point position of the secondary apparatus by applying a tilt correction based on the estimated pose. The secondary apparatus may include an agricultural implement, and the method may further include calculating an application point position of the agricultural implement based on the estimated pose, and recording the application point position for precision agriculture operations. The stored orientation information may be updated only when the primary vehicle is in motion.

According to another aspect, a system for determining pose of a towed implement includes a first positioning receiver mounted on a towing vehicle, a second positioning receiver mounted on the towed implement, and a processor. The processor is configured to receive vehicle orientation data including pitch and roll measurements from the towing vehicle, create a position buffer storing vehicle pose data indexed by geographic coordinates, and receive current position coordinates from the second positioning receiver. The processor is further configured to query the position buffer to retrieve a vehicle pose corresponding to a geographic location proximate to the current position coordinates of the towed implement, construct a terrain plane based on pitch and roll from the retrieved vehicle pose, determine a heading vector of the towed implement relative to the towing vehicle, decompose the heading vector into components relative to the terrain plane, and calculate implement pitch and roll from the decomposed vector components. The first positioning receiver and the second positioning receiver may each include a Global Navigation Satellite System (GNSS) receiver. The vehicle orientation data may be obtained from at least one of an inertial measurement unit (IMU), a magnetometer, or a multi-antenna GNSS system. The position buffer may be configured to store pose data at spatial intervals selected to capture terrain variations. The processor may be further configured to determine a distance between a hitch point of the towing vehicle and an application point of the towed implement, and calculate a spatial delay for retrieving the vehicle pose from the position buffer based on the determined distance. Querying the position buffer may include selecting multiple proximate vehicle poses and interpolating orientation values therefrom. The towed implement may include an agricultural implement and the processor may be further configured to calculate a ground contact point position of the agricultural implement using the calculated implement pitch and roll.

According to another aspect, a method for estimating pose of a secondary apparatus connected to a primary vehicle includes obtaining position information for the primary vehicle and orientation information for the primary vehicle as the primary vehicle travels along a route. The method includes storing the orientation information with associated position information at geographic locations traversed by the primary vehicle. The method further includes obtaining position information for the secondary apparatus, and retrieving stored orientation information corresponding to a geographic location previously traversed by the primary vehicle that is near a current geographic location of the secondary apparatus. The method includes estimating pose of the secondary apparatus based on the retrieved stored orientation information and a spatial relationship between the primary vehicle and the secondary apparatus. The secondary apparatus may include a towed implement. Obtaining position information may include receiving data from positioning receivers mounted on the primary vehicle and the secondary apparatus. The positioning receivers may include Global Navigation Satellite System (GNSS) receivers. The orientation information may include pitch and roll measurements of the primary vehicle. Storing the orientation information with associated position information may include storing vehicle pose measurements in a position buffer indexed by geographic coordinates. The position buffer may store vehicle pose measurements at predetermined distance intervals along the route. Retrieving stored orientation information may include identifying a historical vehicle pose measurement corresponding to a geographic location proximate to the current geographic location of the secondary apparatus. Identifying the historical vehicle pose measurement may include calculating distances between the current geographic location of the secondary apparatus and each geographic location in stored orientation information, and selecting orientation information with a minimum calculated distance. The method may further include identifying a plurality of closest historical vehicle pose measurements to the current geographic location of the secondary apparatus, applying a smoothing filter to orientation values from the plurality of closest historical vehicle pose measurements, and using the smoothed orientation values for estimating pose of the secondary apparatus. The spatial relationship may include a heading difference between the primary vehicle and the secondary apparatus. Estimating pose of the secondary apparatus may include accounting for a directional offset between the primary vehicle and the secondary apparatus when determining how terrain orientation affects the secondary apparatus. Estimating pose may include calculating a terrain plane orientation at the current geographic location of the secondary apparatus based on the retrieved stored orientation information, projecting a heading vector of the secondary apparatus onto the terrain plane, and computing pitch and roll orientation of the secondary apparatus from components of the projected heading vector. Calculating the terrain plane orientation may include applying a rotation matrix defined by extracted pitch and roll values to a vertical reference vector to obtain a terrain normal vector. Projecting the heading vector may include calculating a heading difference vector representing angular offset between primary vehicle heading and secondary apparatus heading, and decomposing the heading difference vector into a component perpendicular to the terrain plane and a component parallel to the terrain plane. Computing pitch orientation of the secondary apparatus may include calculating an arctangent of a ratio of the perpendicular component to the parallel component. Computing roll orientation of the secondary apparatus may include calculating a cross product between the heading difference vector and a perpendicular terrain vector, and computing an arctangent based on components of the cross product. The method may further include determining a contact point position of the secondary apparatus by applying a tilt correction based on the estimated pose. The secondary apparatus may include an agricultural implement, and the method may further include calculating an application point position of the agricultural implement based on the estimated pose, and recording the application point position for precision agriculture operations. The stored orientation information may be updated only when the primary vehicle is in motion.

According to yet another aspect, a method for estimating orientation of a towed implement includes receiving position data from a positioning system mounted on a towing vehicle as the towing vehicle traverses a path. The method includes recording a plurality of vehicle pose measurements at corresponding geographic locations along the path, each vehicle pose measurement including at least pitch and roll orientation of the towing vehicle. The method includes storing the plurality of vehicle pose measurements with associated geographic location data in a position buffer. The method further includes receiving current position data from a positioning system mounted on the towed implement, and identifying, from the position buffer, a historical vehicle pose measurement corresponding to a geographic location proximate to a current location of the towed implement. The method includes extracting pitch and roll values from the identified historical vehicle pose measurement, determining a heading difference between the towing vehicle and the towed implement, calculating a terrain plane orientation at the current location of the towed implement based on the extracted pitch and roll values, projecting a heading vector of the towed implement onto the terrain plane, and computing pitch and roll orientation of the towed implement from components of the projected heading vector. The position buffer may include a distance-based buffer that stores vehicle pose measurements at predetermined distance intervals along the path. Identifying the historical vehicle pose measurement may include calculating distances between the current location of the towed implement and each geographic location in the position buffer, and selecting the vehicle pose measurement with a minimum calculated distance. The method may further include identifying a plurality of closest historical vehicle pose measurements to the current location of the towed implement, applying a smoothing filter to orientation values from the plurality of closest historical vehicle pose measurements, and using the smoothed orientation values for calculating the terrain plane orientation. Calculating the terrain plane orientation may include applying a rotation matrix defined by the extracted pitch and roll values to a vertical reference vector to obtain a terrain normal vector. Projecting the heading vector may include calculating a heading difference vector representing angular offset between vehicle heading and implement heading, and decomposing the heading difference vector into a component perpendicular to the terrain plane and a component parallel to the terrain plane. Computing pitch orientation of the towed implement may include calculating an arctangent of a ratio of the perpendicular component to the parallel component. Computing roll orientation of the towed implement may include calculating a cross product between the heading difference vector and a perpendicular terrain vector, and computing an arctangent based on components of the cross product. The method may further include determining a contact point position of the towed implement by applying a tilt correction based on the computed pitch and roll orientation. The position buffer may store data only when the towing vehicle is in motion. The towed implement may include an agricultural implement, and the method may further include calculating an application point position of the agricultural implement based on the computed pitch and roll orientation, and recording the application point position for precision agriculture operations.

According to another aspect, a system for determining pose of a towed implement includes a first positioning receiver mounted on a towing vehicle, a second positioning receiver mounted on the towed implement, and a processor. The processor is configured to receive vehicle orientation data including pitch and roll measurements from the towing vehicle, create a position buffer storing vehicle pose data indexed by geographic coordinates, and receive current position coordinates from the second positioning receiver. The processor is further configured to query the position buffer to retrieve a vehicle pose corresponding to a geographic location proximate to the current position coordinates of the towed implement, construct a terrain plane based on pitch and roll from the retrieved vehicle pose, determine a heading vector of the towed implement relative to the towing vehicle, decompose the heading vector into components relative to the terrain plane, and calculate implement pitch and roll from the decomposed vector components. The first positioning receiver and the second positioning receiver may each include a Global Navigation Satellite System (GNSS) receiver. The vehicle orientation data may be obtained from at least one of an inertial measurement unit (IMU), a magnetometer, or a multi-antenna GNSS system. The position buffer may be configured to store pose data at spatial intervals selected to capture terrain variations. The processor may be further configured to determine a distance between a hitch point of the towing vehicle and an application point of the towed implement, and calculate a spatial delay for retrieving the vehicle pose from the position buffer based on the determined distance. Querying the position buffer may include selecting multiple proximate vehicle poses and interpolating orientation values therefrom. The towed implement may include an agricultural implement and the processor may be further configured to calculate a ground contact point position of the agricultural implement using the calculated implement pitch and roll.

### BRIEF DESCRIPTION OF THE DRAWINGS

FIG. 1 shows a vehicle driving over a hill in two-dimensional space with variable pitch at different positions along the hill.

FIG. 2 illustrates that merely subtracting the mounting height of a GNSS unit does not result in accurate contact point locations when driving over terrain.

FIG. 3 depicts a vehicle and its pulled implement having different amounts of pitch at the same time when traversing non-flat terrain.

FIG. 4 shows a vehicle and its pulled implement on a side-hill in three-dimensional space.

FIG. 5 illustrates an implement slipping down a hill and not having the same heading as the vehicle.

FIG. 6 shows a virtual plane created from vehicle roll and pitch with the implement's heading vector projected onto it.

FIG. 7 depicts an implement not following the same path as the towing vehicle when traversing a curved route.

FIG. 8 shows a series of locations at which the vehicle's pose is recorded along a traveled path.

FIG. 9 is a flow chart of the process for estimating implement orientation.

FIG. 10 is a block diagram of the system for determining pose of a towed implement.

FIG. 11 is a flow diagram of the method for estimating orientation of a towed implement.

### DETAILED DESCRIPTION

The present disclosure relates to methods and systems for estimating the full pose of a pulled implement or secondary vehicle wherein that platform only needs a GPS unit by relying on the recorded pose of a proceeding vehicle that has traversed the same terrain. This history of pose measurements is then used to estimate the roll and pitch of the terrain over which the secondary platform moves to calculate its roll and pitch.

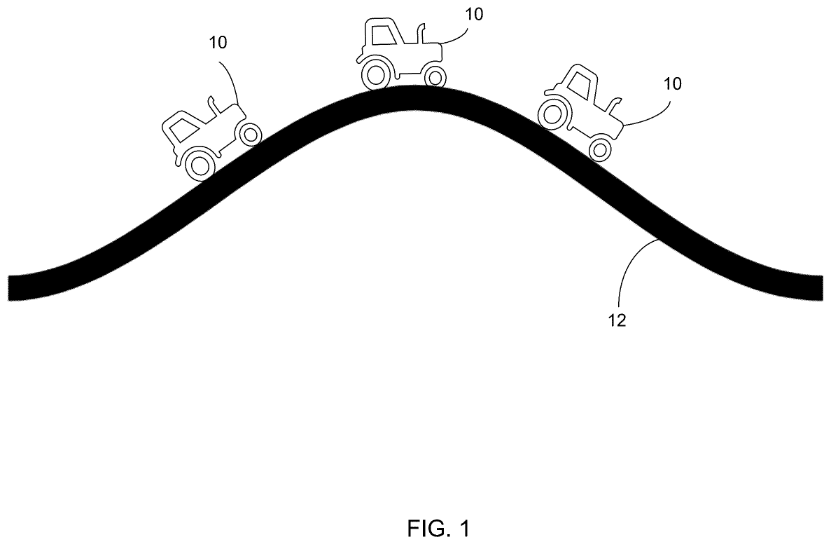

As illustrated in FIG. 1, a vehicle 10 driving in two dimensional space will have a variable pitch as it traverses non-planar terrain 12. For example, while on flat ground, the pitch of the vehicle 10 would be zero but as it begins to drive up hill 12, that pitch would change. At the crest of hill, the pitch of the vehicle 10 would once again be zero until it started to descend, at which point the pitch of the vehicle 10 would again be non-zero but with the opposite sign from when it was driving uphill.

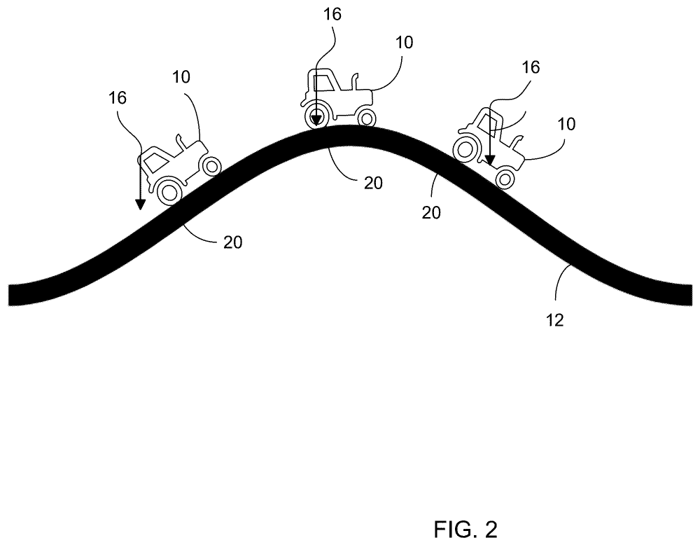

Global Navigation Satellite System (GNSS) units are often used to accurately record the position of a vehicle in navigational space. To ensure that a clear line of sight is maintained with the GNSS satellites, the units are generally mounted on the vehicle's roof. When this unit is to ensure stable readings, the position that is reported is the location of the GNSS unit 16 which is unlikely to be the location of interest for the operator. Referring to FIG. 2, for example, many systems wish to record the position of the point of contact, on the ground, of the rear wheels of the vehicle (hereafter referred to as the contact point 20 and abbreviated as CP). If vehicle 10 is on flat ground and the GNSS unit 16 is positioned directly above the rear wheels, getting the position of CP 20 is merely the reported location of the GNSS unit 16 with its mounting height subtracted from the z-component of the measurement. However, when the vehicle 10 is pitching, merely subtracting the height of the GNSS unit 16 from its readings will not give the position of the CP 20, as clearly shown in FIG. 2. To accurately measure the location of the CP 20, the vehicle's pitch must be accounted for. This can be done by rotating the vector from the GNSS unit 16 to the CP 20 by the vehicle's pitch and then adding that rotated vector onto the GNSS measurement. Assuming the vehicle's pitch is known, correcting for it to accurately record the position of its CP 20 is fairly straightforward. However, accurate measurement of the vehicle's pitch may require expensive hardware such as precision IMU's, robust magnetometers, or carefully calibrated camera systems, just to name a few options. It may, additionally, require advanced computation and sensor fusion methodologies to ensure accuracy in adverse operating conditions.

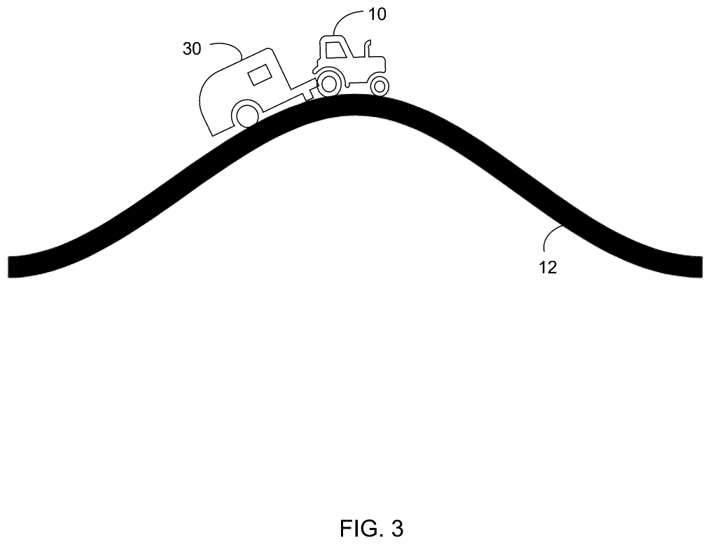

Referring now to FIG. 3, when towing an implement 30, there are a myriad of benefits to knowing its position. For example, when planting or applying fertilizer, it is very beneficial to know where the product is being deposited to ensure that there is even coverage and allow for follow up operations to be conducted without damaging the crop. Modeling the position of the application point of implement 30 can be performed by utilizing an advanced system such as the one just discussed for the vehicle. However, it can be prohibitively expensive to purchase an entire second system just for the implement 30. As such, this is often not done and the position of the applied product is not perfectly known. Thus, it would be very advantageous to accurately estimate the application point of implement 30 without requiring as many sensors.

If we were to put a second GNSS unit on the implement 30, we would be able to estimate its position in real-time. However, we run into the same projection issue that was just discussed for the vehicle 10. That is, when the implement 30 is pitching, the reported position of its mounted GNSS unit needs to be tilt compensated to accurately estimate the position of the application point (or the vehicles control point). One could attempt to use the vehicle's current pitch as the correction for the implement 30, but the implement 30 and the vehicle 10 may have different amounts of pitch at the same time, as shown in FIG. 3. When this occurs, using the vehicle's pitch as the correction for the implement's GNSS readings may actually result in worse estimation of the implement's application point than not using any correction at all. Thus, a different solution must be proposed.

Using the fact that the implement 30 is attached to the vehicle 10, we know that the implement 30 will traverse the same terrain 12 as the vehicle 10 (for the two dimensional case) and that the vehicle's pitch is due to terrain 12 which it drives over. Thus, if we were to keep a history of the vehicle's pitch over time, it would be possible to apply the appropriate pitch value to the implement's GNSS readings.

Knowing the distance from the hitch point of the vehicle 10 to the implement's application point and the speed of the vehicle 10, one can determine how long the delay needs to be. For example, if the length is 5 meters and the vehicle's speed is 1 meters per second (m/s), then the pitch of the implement 30 would be the same as the vehicle's pitch from 5 seconds ago.

While it is certainly possible to utilize a buffer based on time, since vehicles often change their speed, such a buffer may end up with a variable size at each update. As such, in practice, it is easier to utilize a buffer based on distance traversed. For example, one may choose to update the buffer once every 1 meter. Then, at every update the closest point in that buffer 60 to the current location of the implement 30 can be utilized. In practice the spacing or granularity of the points in the buffer may be chosen such that variations in terrain 12 are not missed without creating too many unnecessary points of data. The added advantage of using a positional recorded buffer 60 as opposed to a time based one is that when vehicle 10 is not moving, the buffer need not be updated, which is reasonable since terrain 12 on which vehicle 10 sits (and thus its pitch) would not change while vehicle 10 is stationary.

### Including Roll

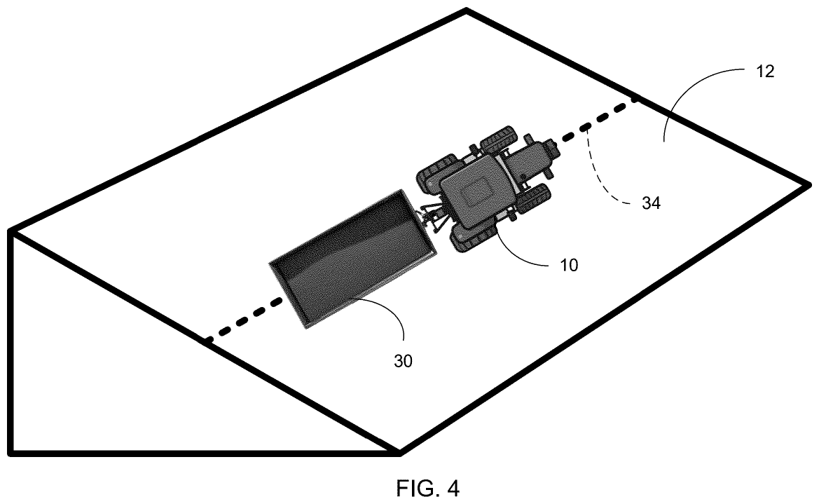

Referring now to FIG. 4, up to this point we have only looked at the two dimensional case. When we introduce a third dimension, we need to account for the vehicle's roll as well as its pitch. It should be clear from the same principles and problems that applied for the pitch only case still apply for the roll and pitch case. That is, for a pulled implement 30, vehicle 10 may have different roll and pitch than implement 30 at any given time but, if implement 30 trails vehicle 10 by a known amount, the implement's roll and pitch can be estimated by a delayed/history of the vehicle's roll and pitch. Doing so allows one to accurately compensate for the tilt of the implement's GNSS measurements. However, the idealized case shown in FIG. 4, wherein implement 30 perfectly tracks the vehicle's path 34 is not representative of reality.

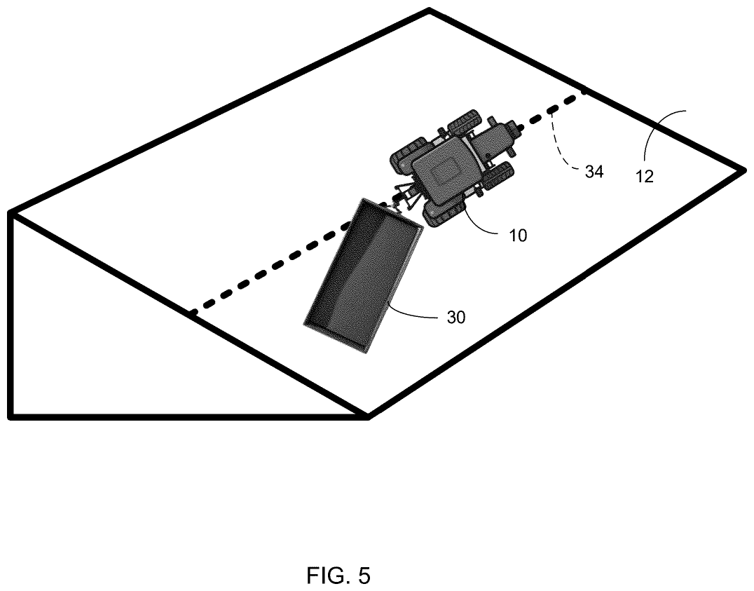

Referring to FIG. 5, when vehicle 10 and its implement 30 are driving along the side of a hill, implement 30 tends to slide down the hill, resulting in implement 30 not traversing the exact same path 36 as vehicle 10. This means that the vehicle's roll and pitch is an imperfect estimate of the implement's roll and pitch. However, if the side slip deviation is small enough, terrain 12 is likely very similar (once the appropriate positional delay has been used) so the vehicle's roll and pitch can still be used to great affect in correcting for the tile of the implement's GNSS unit 112.

That being said, referring again to FIG. 5, it should be clear that the heading of the vehicle 10 and the heading of its pulled implement 30 are not the same when implement 30 does not perfectly track the vehicle's path. It should also be clear, from the same image, that the heading difference between the vehicle 10 and the implement 30 results in the implement 30 having a different roll and pitch than the vehicle 10 even when traversing the same terrain 12. For example, FIG. 5 depicts vehicle 10 traveling parallel to the side of hill of the terrain 12 with a constant slope. In this scenario, since the axis of vehicle 10 is aligned parallel to the hill, vehicle 10 has no pitch but it does have roll and the vehicle's roll is the same as the slope of hill 12. However, since the implement 30 does not have the same heading as the vehicle 10, it is not aligned with the hill 12. Consequently, the implement 30 has both roll and pitch as some of the hill's slope will translate into roll and some will translate into pitch.

### Vector Projection Method

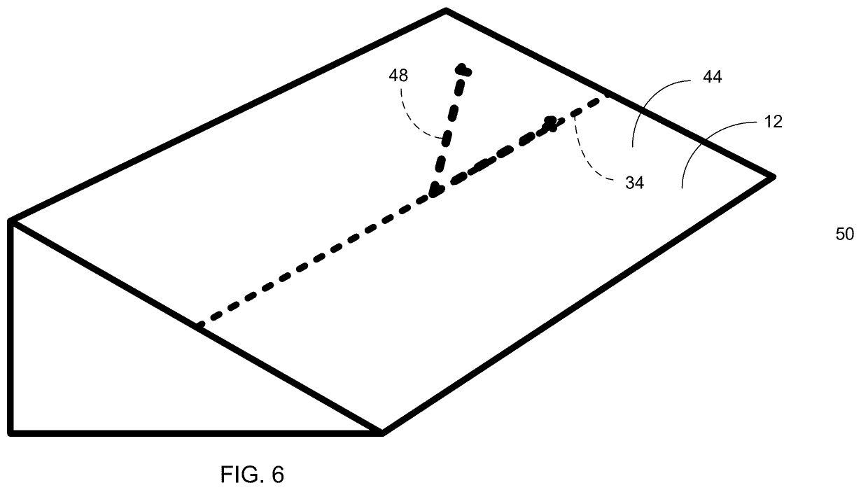

Referring now to FIG. 6, if one takes the heading vector 48 of the implement and projects it onto a virtual plane 44 created from the roll and pitch of the vehicle (at the appropriate geographic location), as shown in FIG. 6, then the roll and pitch of the implement can be calculated.

One way to project the heading vector 48 of the implement onto this virtual plane 44 is to align the x-axis of the plane 44 with the heading of the vehicle, then calculate the heading vector 48 of the implement in relation to that reference frame. The heading difference vector can be calculated as:

$${ψ}_{diff} = [ cos ( {ψ}_{diff} ) , sin ( {ψ}_{diff} ) , 0. ] ,$$

where ψ represents heading and the difference in heading between the vehicle and the implement can be calculated as ψ_{diff}=ψᵢₘₚ−ψᵥₑₕ. This heading difference vector is now in the x direction of travel of the vehicle and thus correctly aligned with the x axis but it is not yet on the xy-plane defined by the vehicle's roll and pitch. To accomplish that, we need to split the heading vector 48 into its two components in relation to the plane 44. That is, we can say that ψ_{diff} can be defined by the sum of two vectors wherein one is perpendicular to the terrain plane 44 and the other is parallel to the plane 44. This can be written as:

$${ψ}_{diff} = {v}_{ψ diff ⊥} , + {v}_{ψ diff , ‖}$$

from which it follows that:

$${ψ}_{diff , ‖} = {ψ}_{diff} - {ψ}_{diff , ⊥} .$$

We have already defined ψ_{diff}, thus to calculate the heading vector projected onto the plane, ψ_{diff}, ∥, we need to compute ψ_diff,⊥. Fortunately, this can be done by projecting the heading difference vector, ψ_diff, onto a vector that is perpendicular to the plane 44. Such a vector could be calculated by taking the cross product of a vector defined by the vehicle's pitch with one defined by its roll. Alternatively, one could calculate it by applying a rotation matrix R(φ, θ, 0) to a vector perpendicular to the xy-plane (ie the z-axis vector). This could be calculated as:

$${v}_{⊥} = ℛ ( ϕ , θ , 0 ) * [ \begin{matrix}0 \\ 0 \\ 1\end{matrix} ]$$

where [symbol] (φ, θ, 0) is a standard rotation matrix as defined by the vehicle's historical roll and pitch. Note that there's no y since the plane 44 is aligned with the vehicle's heading. Then we can calculate v_{ψdiff,⊥} by projecting the heading difference vector onto the perpendicular vector as:

$${ψ}_{diff , ⊥} = {proj}_{v ⊥} ( {ψ}_{diff} )$$

where that projection calculation is the standard vector projection defined as:

$${proj}_{b} ( α ) = \frac{a \cdot b}{b \cdot b} b .$$

With that calculation we can now say that the implement vector on the terrain, v_{imp on terrain}, is:

$${v}_{imp on terrain} = {ψ}_{diff , ‖} = {ψ}_{diff} - {proj}_{v ⊥} ( {ψ}_{diff} )$$

This vector would only supply sufficient data to calculate the implement's pitch and not its roll. Thus, this same process must be repeated with a vector that is perpendicular to the heading difference vector. That is, one would start with the following vector:

$$⊥ {ψ}_{diff} = [ cos ( {ψ}_{diff} + π / 2 ) , sin ( {ψ}_{diff} + π / 2 ) , 0. ] ,$$

and, by following the same process would get:

$$⊥ {v}_{imp on terrain} = ⊥ {ψ}_{diff} - {proj}_{v ⊥} ( {v}_{diff} ) .$$

Finally, the implement's roll can be calculated as:

$$ϕ = arctan \frac{( ⊥ {ψ}_{diff} \times ⊥ {v}_{imp on terrain} ) \cdot {ψ}_{diff}}{⊥ {ψ}_{diff} \cdot ⊥ {v}_{imp on terrain}}$$

and its pitch can be calculated as:

$$θ = arctan \frac{( {ψ}_{diff} \times {v}_{imp on terrain} ) \cdot ⊥ {v}_{imp on terrain} )}{{ψ}_{diff} \cdot {v}_{imp on terrain}}$$

where the cross products in the numerators serve to ensure that the sign of the roll and pitch are properly retained.

Using these equations, we can calculate the implement's roll and pitch. Given that we already know its heading from the GNSS data, we can compute a rotation matrix using its roll, pitch, and yaw to correctly tilt compensate for the implement's GNSS measurements and correctly estimate the position of its application point.

### Non-Straight Guidance Line

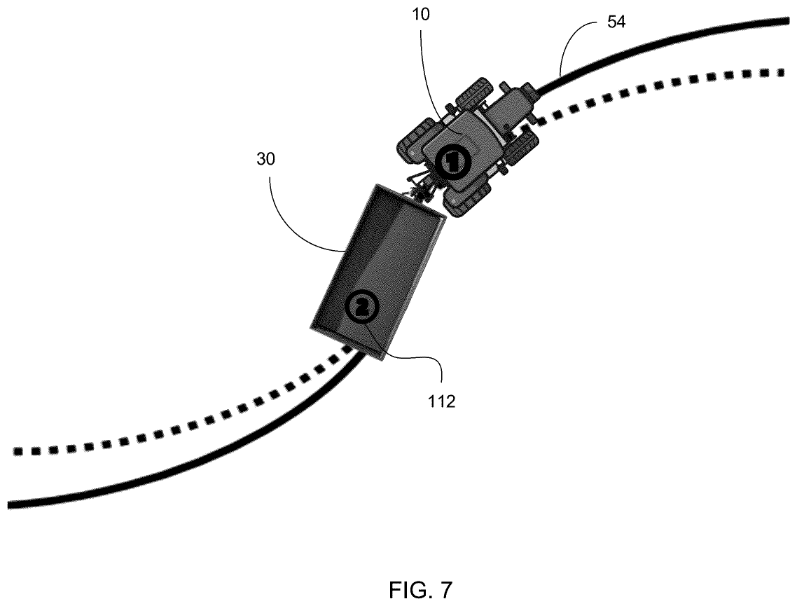

Referring to FIG. 7, up to this point we have considered vehicle 10 traversing a straight line. However, it is often the case that vehicle 10 will not be following a perfectly straight guidance line. For example, a farmer planting a field may need to steer around a pond, the edge of his field, or some other obstacle that would prevent him from using straight guidance lines. When vehicle 10 drives along a curved route 54, a pulled implement 30 does not perfectly track the guidance line that the vehicle 10 is on. This is shown in FIG. 7.

In such a case, we can use the same process as discussed for the side hill scenario. That is, we make the assumption that terrain does not differ too much between the current position of the implement 30 and its closest corresponding location on the original guidance line 54 which was driven by vehicle 10. Thus, if we store a series of data points, with sufficient close spacing so as to not lose resolution, then at each time update (e.g. on a new GNSS message from the unit 112 on the implement 30), we can find the closest point in that history to the implement's current position. We would then calculate the implement's roll and pitch as previously discussed.

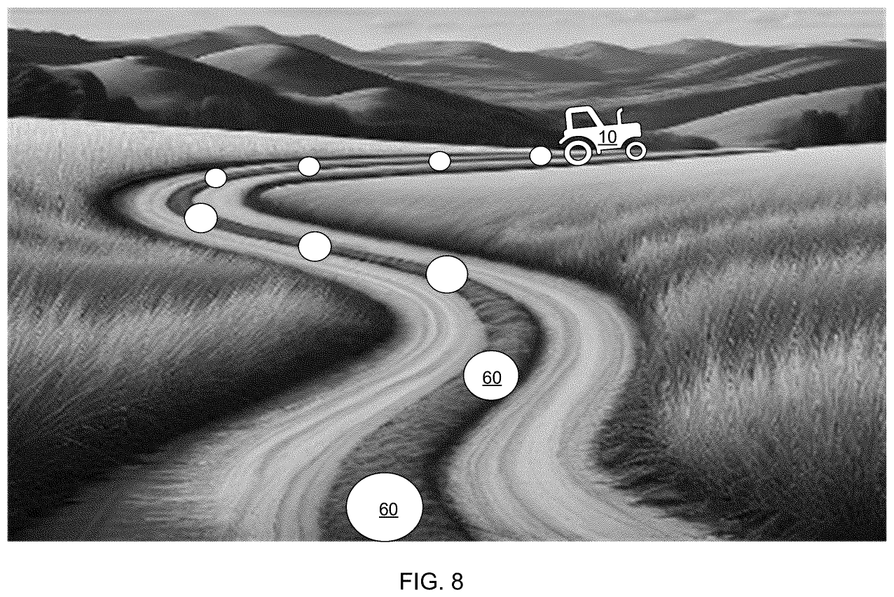

Referring to FIG. 8, in practice, one may choose to find not just the closest point but a series of the closest points to allow for interpolation between two points or to apply a filter or smoother to a series of points, thereby increasing the accuracy of the estimated roll and pitch of the terrain under the implement. Furthermore, one could apply this same logic to create a topographic map of the field or terrain for use in future operations. That is, the roll and pitch of subsequent vehicles could also be estimated in this same way given a sufficiently large history of data points 60 from the original vehicle 10. Doing so could be represented as shown in FIG. 8.

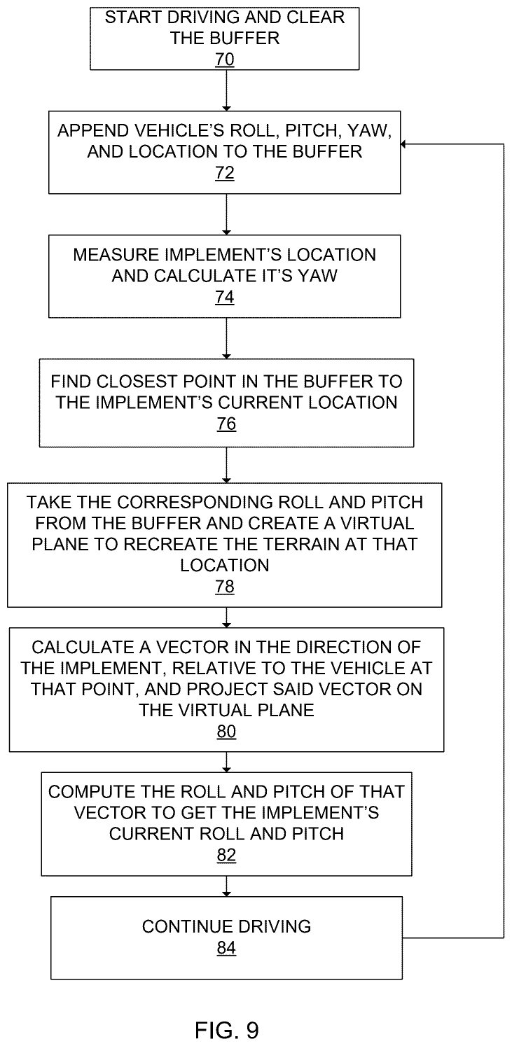

Referring to FIG. 9, a summary of the process can be found in the flowchart shown. Note that the filtering or smoothing of the n closest points to the implement's current location is left out of this flow chart for the sake of brevity.

As shown in FIG. 9, in a first step 70, the vehicle may start driving and the buffer may be cleared. The vehicle may be driven by an operator or may be autonomously driven or semi-autonomously driven. Next in step 72, the vehicle's roll, pitch, yaw and location may be appended to the buffer. In step 74, the implement's location may be measured and the yaw calculated. In step 76, the closest point in the buffer to the implement's current location may be determined. In step 78, the corresponding roll and pitch from the buffer may be used to create a virtual plane to recreate the terrain at that location. Next in step 80, a vector is calculated in the direction of the implement, relative to the vehicle at that point, and the vector is projected on the virtual plane. In step 82, the roll and pitch of that vector are computed to obtain the implement's current pitch and roll. In step 84, driving may be continued and the process may be repeated in a loop, returning to step 72.

### System Implementation

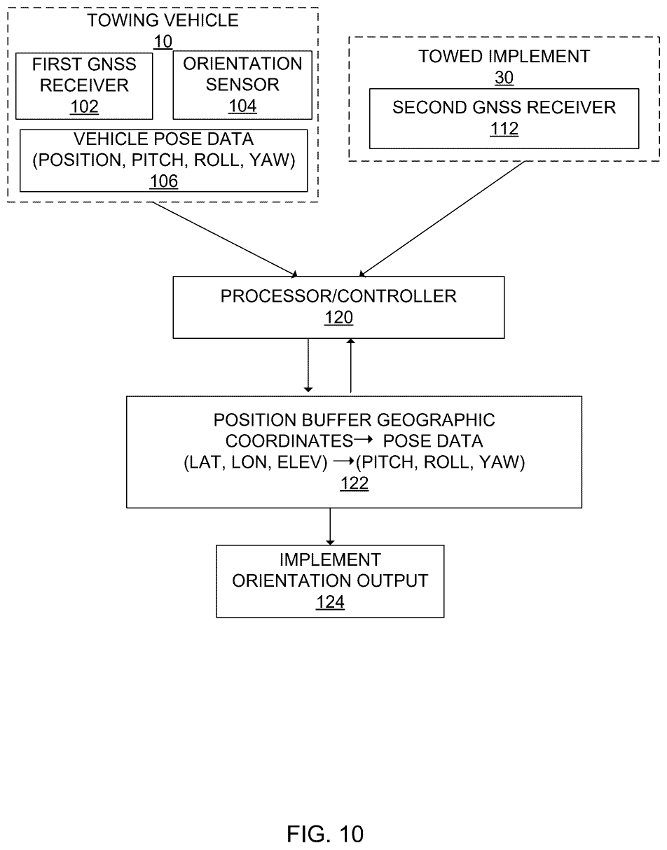

Referring now to FIG. 10, one example of a system for determining pose of a towed implement 30 may include a first positioning receiver 102 mounted on towing vehicle 10, and a second positioning receiver 112 mounted on towed implement 30. In a preferred embodiment, first positioning receiver 102 and second positioning receiver 112 each include a Global Navigation Satellite System (GNSS) receiver which may, for example, be GPS receivers.

The system further includes an orientation sensor 104 associated with towing vehicle 10. Orientation sensor 104 may include an inertial measurement unit (IMU), a magnetometer, a multi-antenna GNSS system, or any combination thereof capable of determining the pitch, roll, and yaw of vehicle 10.

Vehicle pose data 106 including position, pitch, roll, and yaw information is generated by combining data from first positioning receiver 102 and orientation sensor 104. This vehicle pose data 106 is transmitted to a processor 120.

The processor 120 is configured to receive vehicle pose data 106 and current position data from second positioning receiver 112 on implement 30. Processor 120 creates and maintains position buffer 122, which stores vehicle pose data indexed by geographic coordinates. Position buffer 122 may be implemented as a memory storage device, database, or other suitable data structure capable of storing and retrieving pose information based on spatial location.

Processor 120 queries position buffer 122 to retrieve a vehicle pose corresponding to a geographic location proximate to the current position coordinates of implement 30. The processor 120 then constructs a virtual terrain plane 44 based on pitch and roll from the retrieved vehicle pose, determines a heading vector 48 of implement 30 relative to vehicle 10, decomposes the heading vector 48 into components relative to the terrain plane 44, and calculates implement pitch and roll from the decomposed vector components.

The calculated implement orientation 124 is then output and may be used to determine the precise ground contact point or application point of implement 30, thereby enabling accurate position tracking for precision agriculture or other applications.

### Method Implementation

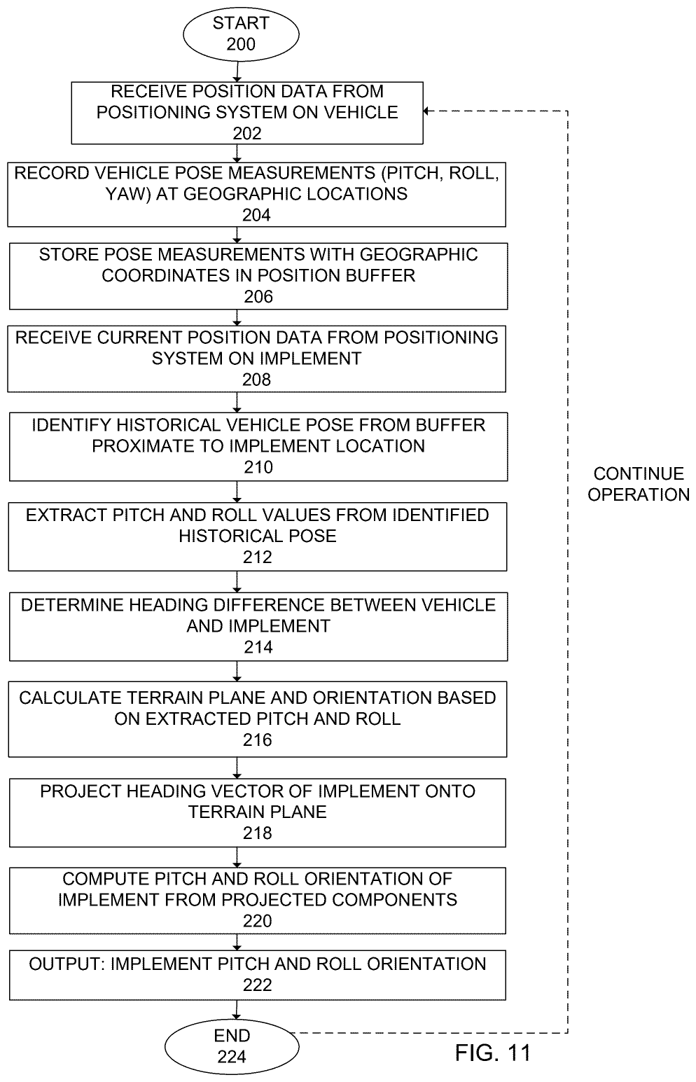

Referring now to FIG. 11, the method for estimating orientation of a towed implement is provided.

At step 202, position data is received from a positioning system mounted on towing vehicle 10 as the towing vehicle traverses a path.

At step 204, a plurality of vehicle pose measurements are recorded at corresponding geographic locations along the path, each vehicle pose measurement comprising at least pitch and roll orientation of towing vehicle.

At step 206, the plurality of vehicle pose measurements are stored with associated geographic location data in position buffer.

At step 208, current position data is received from a positioning system mounted on towed implement.

At step 210, a historical vehicle pose measurement is identified from position buffer corresponding to a geographic location proximate to a current location of towed implement.

At step 212, pitch and roll values are extracted from the identified historical vehicle pose measurement.

At step 214, a heading difference between towing vehicle and towed implement is determined.

At step 216, a terrain plane orientation at the current location of towed implement is calculated based on the extracted pitch and roll values.

At step 218, a heading vector of the towed implement is projected onto terrain plane.

At step 220, pitch and roll orientation of the towed implement are computed from components of the projected heading vector.

At step 222, the computed implement pitch and roll orientation is output for use in determining the precise position of implement.

When in continuous operation, as indicated by the dashed line, the process returns to step 202.

This iterative process allows for real-time estimation of implement orientation as both the vehicle and implement continue to move across varying terrain, providing continuous accurate positioning information without requiring expensive orientation sensing equipment on the implement itself.

Thus, methods and systems have been provided. Note that various embodiments may provide a number of significant advantages over prior art systems. One advantage is cost reduction. By requiring only a positioning receiver on the implement rather than a complete orientation sensing system, equipment costs may be significantly reduced. This also simplifies the system in that it avoids any calibration requirements or maintenance requirements associated with complete orientation sensing systems. A further advantage is accuracy. The method provides accurate implement orientation estimation even when the implement does not perfectly track the vehicle path, such as on side hills or curved routes. A further advantage is versatility. The position buffer approach works for any path configuration, whether straight or curved, and adapts to varying terrain conditions. Another advantage is that the data collected may be used for additional applications. For example, the collected pose data can be used to create topographic maps for future operations, providing value beyond immediate implement tracking. Another advantage is the robustness of the system. The optional use of smoothing and interpolation techniques with multiple buffer points increases accuracy and reduces the impact of measurement noise.

### Variations, Options, and Alternatives

Those skilled in the art will recognize that the present disclosure admits of numerous variations, alternatives, and options without departing from the scope and spirit of the invention.

The positioning receivers 102, 112 described herein may comprise any suitable satellite-based positioning system, including but not limited to GPS (Global Positioning System), GLONASS (Global Navigation Satellite System), Galileo, BeiDou, or any combination thereof. The positioning receivers may be single-frequency or multi-frequency receivers, and may employ differential correction techniques such as RTK (Real-Time Kinematic), PPP (Precise Point Positioning), or SBAS (Satellite-Based Augmentation System) to enhance accuracy.

The orientation sensor for determining vehicle pitch, roll, and yaw may be implemented using various technologies. In one embodiment, the orientation sensor includes a multi-axis inertial measurement unit (IMU) containing accelerometers and gyroscopes. In another embodiment, the orientation sensor includes a magnetometer or compass in combination with an IMU. In yet another embodiment, the orientation sensor includes a multi-antenna GNSS system wherein the relative positions of multiple GNSS antennas on the vehicle are used to calculate orientation. In still another embodiment, the orientation sensor may include a camera-based system that determines orientation from visual features. Any combination of these technologies may be employed, and sensor fusion techniques may be used to combine data from multiple orientation sensing devices.

The position buffer may be implemented in various forms. In one embodiment, the position buffer includes a circular buffer of fixed size, wherein older data is overwritten as new data is added. In another embodiment, the position buffer includes a dynamically allocated memory structure that grows as needed. The buffer may be stored in volatile memory such as RAM, or in non-volatile memory such as flash storage or a solid-state drive. The buffer may be maintained locally on a processor, or may be stored remotely on a server or cloud-based system accessible via wireless communication.

The spacing or granularity of data points stored in the position buffer may vary depending on application requirements. In one embodiment, vehicle pose data is stored at regular distance intervals, such as every 0.5 meters, 1 meter, 2 meters, or any other suitable interval. In another embodiment, vehicle pose data is stored at regular time intervals, such as every 0.1 seconds, 0.5 seconds, or 1 second. In yet another embodiment, vehicle pose data is stored adaptively based on detected changes in terrain, wherein data is stored more frequently when significant changes in pitch or roll are detected, and less frequently on uniform terrain. The buffer may store only the most recent data from a single pass, or may accumulate data from multiple passes to build a comprehensive terrain map.

The method of identifying the historical vehicle pose measurement may be implemented in various ways. In one embodiment, a nearest-neighbor search is performed to find the single closest point in position buffer to the current implement location. In another embodiment, multiple nearby points are identified and their orientation values are interpolated based on distance weighting. In yet another embodiment, a filtered or smoothed value is calculated from a plurality of nearby points using techniques such as moving average, Gaussian smoothing, or Kalman filtering. The proximity search may be performed in two dimensions (latitude and longitude) or in three dimensions (including elevation).

The calculation of terrain plane orientation may employ various mathematical representations. In one embodiment, the terrain plane is defined by a normal vector calculated using the rotation matrix method described herein. In another embodiment, the terrain plane is defined by three points or by a plane equation in the form ax+by +cz=d. Alternative rotation conventions such as Euler angles, quaternions, or axis-angle representations may be used for orientation calculations.

The vector projection method described herein may be implemented using various mathematical techniques. While the preferred embodiment uses the standard dot product-based vector projection, alternative projection methods such as orthogonal decomposition, Gram-Schmidt orthogonalization, or matrix-based projections may be employed. The arctangent functions used to calculate roll and pitch may be implemented as aₜₐₙ, aₜₐₙ², or other suitable inverse trigonometric functions depending on the desired range and quadrant handling.

The system may be implemented with a processor located on the vehicle, on the implement, or as a separate unit in communication with both. In one embodiment, the processor is integrated with the first positioning receiver in a single housing mounted on the vehicle. In another embodiment, the processor may be integrated with second positioning receiver on the implement. In yet another embodiment, processing is distributed between multiple processors, with some calculations performed on the vehicle and others performed on the implement. Communication between components may be via wired connections, wireless connections (such as Bluetooth, Wi-Fi, or proprietary RF links), or a combination thereof. Where the term “processor” is used, it is to be understand to include more than one processor where processing function is distributed between processors.

The methods and systems are applicable to various types of towed implements and secondary vehicles. While agricultural implements such as planters, fertilizer applicators, sprayers, and tillage equipment are specifically contemplated, the methods are equally applicable to any other towed apparatus where accurate position determination is desired. The methods may be used with rigid hitches, articulated hitches, or flexible connections between the vehicle and the implement.

The method may be extended to accommodate multiple towed implements in series. In one embodiment, a second implement is towed behind first implement, and the orientation of the second implement is estimated using historical pose data.

In one embodiment, the computed implement orientation is used to calculate the ground contact point or application point of the implement, and this position is recorded for mapping or record-keeping purposes. In another embodiment, the implement orientation is used to control the operation of the implement, such as adjusting application rates, controlling implement depth, or activating/deactivating sections of the implement. In yet another embodiment, the orientation data is transmitted to a remote server for fleet management, precision agriculture analysis, or regulatory compliance documentation.

The historical pose data accumulated in the position buffer may be used for additional purposes beyond immediate implement orientation estimation. In one embodiment, the data is processed to generate a topographic map showing terrain elevation, slope, and aspect. In another embodiment, statistical analysis is performed on the pose data to identify areas of consistent terrain characteristics for field management purposes. The pose data may be correlated with other data such as soil samples, yield data, or imagery to provide enhanced agricultural insights.

The foregoing descriptions of variations, alternatives, and options are intended to be illustrative rather than exhaustive. Those skilled in the art will recognize that numerous other modifications and variations may be made without departing from the scope of the invention as defined by the appended claims.

1. A method for estimating pose of a secondary apparatus connected to a primary vehicle, comprising:
obtaining position information for the primary vehicle and orientation information for the primary vehicle as the primary vehicle travels along a route;
storing the orientation information with associated position information at geographic locations traversed by the primary vehicle;
obtaining position information for the secondary apparatus;
retrieving stored orientation information corresponding to a geographic location previously traversed by the primary vehicle that is near a current geographic location of the secondary apparatus to provide retrieved stored orientation information; and
estimating pose of the secondary apparatus based on the retrieved stored orientation information and a spatial relationship between the primary vehicle and the secondary apparatus.

2. The method of claim 1, wherein the secondary apparatus comprises a towed implement.

3. The method of claim 1, wherein obtaining position information comprises receiving data from positioning receivers mounted on the primary vehicle and the secondary apparatus.

4. The method of claim 3, wherein the positioning receivers comprise Global Navigation Satellite System (GNSS) receivers.

5. The method of claim 1, wherein the orientation information comprises pitch and roll measurements of the primary vehicle.

6. The method of claim 1, wherein storing the orientation information with associated position information comprises storing vehicle pose measurements in a position buffer indexed by geographic coordinates.

7. The method of claim 6, wherein the position buffer stores vehicle pose measurements at predetermined distance intervals along the route.

8. The method of claim 1, wherein retrieving stored orientation information comprises identifying a historical vehicle pose measurement corresponding to a geographic location proximate to the current geographic location of the secondary apparatus.

9. The method of claim 8, wherein identifying the historical vehicle pose measurement comprises:
calculating distances between the current geographic location of the secondary apparatus and each geographic location in stored orientation information; and
selecting orientation information with a minimum calculated distance.

10. The method of claim 9, further comprising:
identifying a plurality of closest historical vehicle pose measurements to the current geographic location of the secondary apparatus;
applying a smoothing filter to orientation values from the plurality of closest historical vehicle pose measurements; and
using the smoothed orientation values for estimating pose of the secondary apparatus.

11. The method of claim 1, wherein the spatial relationship comprises a heading difference between the primary vehicle and the secondary apparatus.

12. The method of claim 1, wherein estimating pose of the secondary apparatus comprises accounting for a directional offset between the primary vehicle and the secondary apparatus when determining how terrain orientation affects the secondary apparatus.

13. The method of claim 12, wherein estimating pose comprises:
calculating a terrain plane orientation at the current geographic location of the secondary apparatus based on the retrieved stored orientation information;
projecting a heading vector of the secondary apparatus onto the terrain plane; and
computing pitch and roll orientation of the secondary apparatus from components of the projected heading vector.

14. The method of claim 13, wherein calculating the terrain plane orientation comprises applying a rotation matrix defined by extracted pitch and roll values to a vertical reference vector to obtain a terrain normal vector.

15. The method of claim 13, wherein projecting the heading vector comprises:
calculating a heading difference vector representing angular offset between primary vehicle heading and secondary apparatus heading; and
decomposing the heading difference vector into a component perpendicular to the terrain plane and a component parallel to the terrain plane.

16. The method of claim 15, wherein computing pitch orientation of the secondary apparatus comprises calculating an arctangent of a ratio of the perpendicular component to the parallel component.

17. The method of claim 15, wherein computing roll orientation of the secondary apparatus comprises:
calculating a cross product between the heading difference vector and a perpendicular terrain vector; and
computing an arctangent based on components of the cross product.

18. The method of claim 1, further comprising determining a contact point position of the secondary apparatus by applying a tilt correction based on the estimated pose.

19. The method of claim 18, wherein the secondary apparatus comprises an agricultural implement, and further comprising:
calculating an application point position of the agricultural implement based on the estimated pose; and
recording the application point position for precision agriculture operations.

20. A system for determining pose of a towed implement, comprising:
a first positioning receiver mounted on a towing vehicle;
a second positioning receiver mounted on the towed implement;
a processor configured to:
receive vehicle orientation data comprising pitch and roll measurements from the towing vehicle;
create a position buffer storing vehicle pose data indexed by geographic coordinates;
receive current position coordinates from the second positioning receiver;
query the position buffer to retrieve a vehicle pose corresponding to a geographic location proximate to the current position coordinates of the towed implement to provide a retrieved vehicle pose;
construct a terrain plane based on pitch and roll from the retrieved vehicle pose;
determine a heading vector of the towed implement relative to the towing vehicle;
decompose the heading vector into components relative to the terrain plane to provide decomposed vector components; and
calculate implement pitch and roll from the decomposed vector components.

21. The system of claim 20, wherein the first positioning receiver and the second positioning receiver each comprise a Global Navigation Satellite System (GNSS) receiver.

22. The system of claim 20, wherein the vehicle orientation data is obtained from at least one of: an inertial measurement unit (IMU), a magnetometer, or a multi-antenna GNSS system.

23. The system of claim 20, wherein the position buffer is configured to store pose data at spatial intervals selected to capture terrain variations.

24. The system of claim 20, wherein the processor is further configured to:
determine a distance between a hitch point of the towing vehicle and an application point of the towed implement; and
calculate a spatial delay for retrieving the vehicle pose from the position buffer based on the determined distance.

25. The system of claim 20, wherein querying the position buffer comprises selecting multiple proximate vehicle poses and interpolating orientation values therefrom.

26. The system of claim 20, wherein the towed implement comprises an agricultural implement and the processor is further configured to calculate a ground contact point position of the agricultural implement using the calculated implement pitch and roll.
